(19) United States
(12) Patent Application Publication
(10) Pub. No.: US 2025/0140137 A1
(43) Pub. Date: May 1, 2025

(54) Advertising Apparatus For a Harrow

(71) Applicant: Joel Brainard, Edmond, OK (US)

(72) Inventor: Joel Brainard, Edmond, OK (US)

(21) Appl. No.: 18/494,507

(22) Filed: Oct. 25, 2023

(51) Int. Cl. G09F 21/04; A01B 25/00; G09F 7/18; G09F 9/30

(52) U.S. Cl. CPC G09F 21/04; A01B 25/00; G09F 7/18; G09F 9/30; G09F 2007/1843; G09F 2007/1852; G09F 2007/1865

(57) ABSTRACT

An advertising apparatus for a harrow to present advertising material to an audience. The advertising apparatus having at least one media display and a frame support. The frame support is removably attached to the exterior of the harrow by direct or indirect connections. Each media display is removably and rotatably attached to the frame support by direct or indirect connections.

### CROSS-REFERENCE TO RELATED APPLICATIONS

None.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood these statements are to be read in this light, and not as admissions of prior art.

The field of the invention generally relates to stadium advertising and related arenas for advertising to a viewing audience. In particular, the invention relates to advertising in horse competition stadiums, where a removable advertising apparatus is mounted to a harrow.

Advertising in competition arenas is not new. Competition is steep to advertise in stadiums and often very expensive to maintain advertising signage. There is a need to be creative with the advertisements to create the best return on investment and to target advertisements to relevant audiences.

It is well known that stadiums are commonly used to host various events. Sport stadiums can be used for a range of events from sports to concerts, to festivals. Because of the diverse crowds, fixed advertisements, such as scoreboard advertising, concourse signage, and restroom ads, may not be relevant to all audiences. Horse competition environments are a niche sport with a specific audience. Therefore, it is desirable to target advertisements to this audience.

It is well known that during horse competitions the soil needs to be tilled between competitors with a harrow, otherwise commonly known as an arena drag, to provide an equal playing field for each competitor. While the soil is being tilled there is a significant downtime for the viewing audience. This valuable downtime can be used to advertise to the audience; however, currently there is no meaningful way to interact with the audience while an arena drag tills the soil. Arena drags are common and necessary for each horse competition. Therefore, is it desirable for an apparatus that is moveable for attachment to an arena drags to provide advertisements to the audience.

For the foregoing reasons, there is a need for a moveable advertising apparatus in horse competition arenas.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The present invention is directed to an apparatus that satisfies the need to provide advertisements to a live audience in horse competition arenas. The advertising apparatus comprises a harrow, a media display and a frame support.

Although it is well known to mount to an electronic display to a exterior surfaces, such as a wall outside, it is not obvious to mount an electronic display to an agricultural machine such as a harrow. Harrows have a specific purpose of tilling the ground and are designed for use outdoors. Thus, current art does not disclose a method for mounting an electronic display.

### BRIEF DESCRIPTION OF THE DRAWINGS

These and other features, aspects, and advantages of the present invention will become better understood with regard to the following description, appended claims, and accompanying drawings where:

FIG. 1 is an elevation view of the advertising apparatus and harrow featuring a water tank in accordance with an embodiment of the present disclosure; and

FIG. 2 is an elevation view of the advertising apparatus and harrow in accordance with an embodiment of the present disclosure.

### DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the” and “said” are intended to mean that there are one or more of the elements. The terms “comprising,” “including,” “having,” and grammatical equivalents thereof are intended to be inclusive and mean that there may be additional elements other than the listed elements.

Moreover, any use of “top,” “bottom,” “above,” “below,” other directional terms, and variations of these terms is made for convenience, but does not require any particular orientation of the components.

The term “at least” followed by a number is used herein to denote the start of a range beginning with that number (which may be a range having an upper limit or no upper limit, depending on the variable being defined). For example, “at least 1” means 1 or more than 1.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40-%.

When in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit 100 mm.

“Arena drag” refers to a grooming device for arena maintenance. The arena drag is a type of harrow intended to fluff up any area of compacted footing and make the footing conditions uniform across the entire arena. As horses stride in the same places, such as in a ring outlining the perimeter of the arena, the outside is commonly packed-down. Dragging restores the footing to its ideal state.

“Electronic display” refers to a screen for presentation of images, text, or video transmitted electronically, without producing a permanent record. Electronic displays include television sets, computer monitors, digital signage and projectors (along with a screen onto which the text, images, or video is projected).

“Energy source” refers to a device to capture or generate energy produced at one time for use at a later time to reduce imbalances between energy demand and energy production. Common energy sources include batteries or fuel cells, generators or alternators, solar power converters.

“Harrow” refers to a farm implement used for surface tillage. It is used for breaking up and smoothing out the surface of the soil.

“Media display” refers to any kind of display medium for presenting images, text, video, signs, or symbols to an audience.

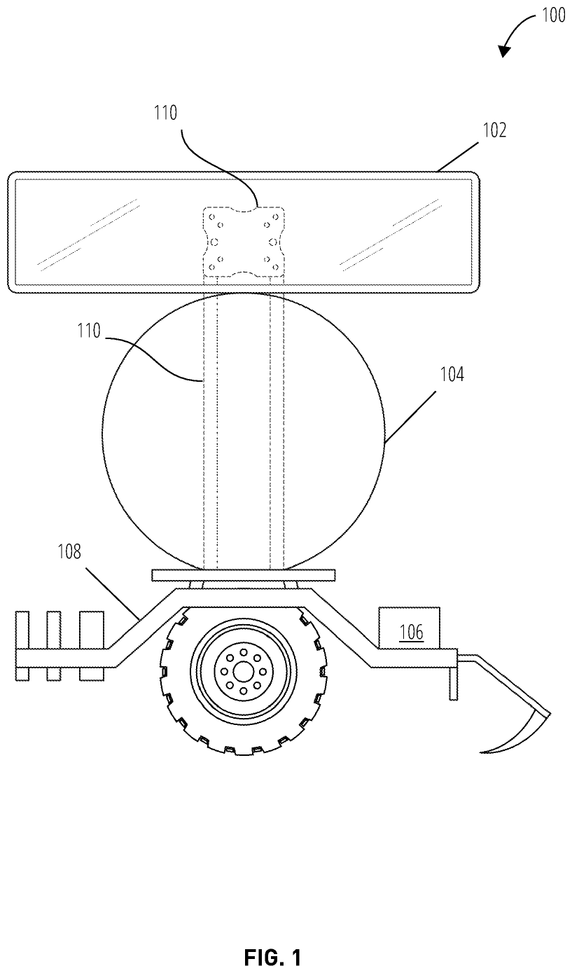

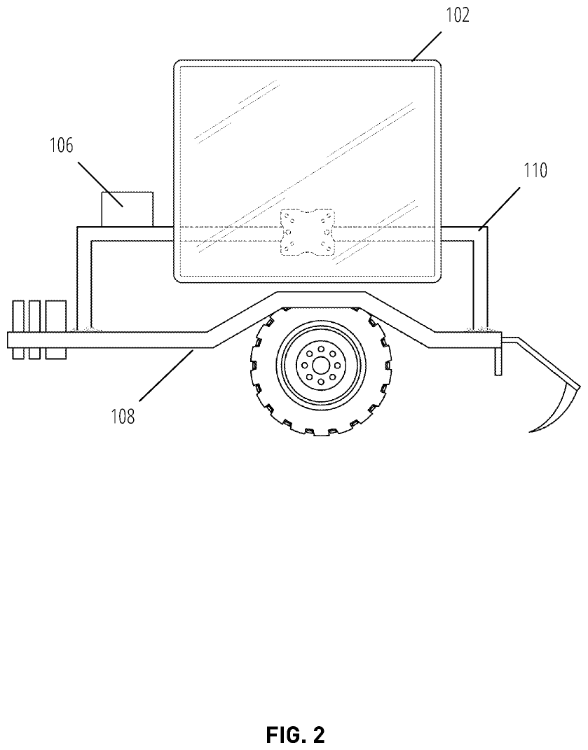

It is known to one skilled in the art that a harrow 108 for tilling the ground of horse competition arenas, otherwise known as “arena drags,” come in various forms. Two common types of harrows 108 are one with a water tank 104 as shown in FIG. 1, and without one shown in FIG. 2.

Turning to the present figures, FIG. 1 is a side elevation view of the advertising apparatus 100 attached to a harrow 108 featuring a water tank 104.

The advertising apparatus 100 is configured to present advertising material through the media display 102 to an audience. The media display 102 may be substantially horizontal to accommodate common display aspect ratios such as 16:9, but it may also be square or substantially vertical for other aspect ratios. In a preferred embodiment, the media display 102 is an electronic display, which may be an electronic signboard, a liquid crystal display (LCD) screen, or a light emitting diode (LED) screen. In other embodiments, the media display 102 can be a static display such as a sign or poster. In a preferred embodiment, the media display 102 is mounted to the frame support 110 above the tank 104, as featured in FIG. 1. In some embodiments the media display 102 may be removable and rotatable.

In another embodiment of the invention, the advertising apparatus 100 can be configured to have more than one media display 102. In one embodiment, two media displays 102 can be on opposing ends of the harrow 108 symmetrically about the shorter edge of the harrow 108. In yet another embodiment, there may be two or more media display 102 of similar or different sizes to produce a unified image or various individual images.

The frame support 110 is for removably attaching the media display 102 to the harrow 108. The frame support 110 attaches to the harrow 108 without affecting the tilling performance of the harrow 108. Furthermore, the frame support 110 can accommodate a tank 104, as demonstrated with the dotted lines. The frame support 110 may connect to the harrow 108 and media display 102 by indirect or direct connections. Indirect connections can include cables, clamps, or ties. Direct connections can include nuts and bolts, adhesives, or magnets. The frame support 110 may be metal, plastic or wood for removable attachment to the harrow 108. In a preferred embodiment, the media display 102 is removably attached to the frame support 110 by direct connections such as nuts and bolts. The media display 102 and frame support 110 can be removed and stored for future use.

In a preferred embodiment, the frame support 110 rests directly above the tank 104; however, to one skilled in the art, the frame support 110 may be configured for different models of harrows 108. Furthermore, the height of the frame support 110 can be configured for different heights appropriate for the viewing audience.

The power supply 106 provides a source of power to the media display 102 while the harrow 108 is in operation. The power supply 106 is removably mounted to the harrow 108. The power supply 106 can be attached to the harrow 108, as shown in FIG. 1, or it can be attached to the frame support 110. In a preferred embodiment, the power supply 106 is a battery. In other embodiments, the power supply 106 may be provided by the harrow itself or by an energy source.

FIG. 2 is a side elevation view of the advertising apparatus 100 attached to a simple harrow 108 in accordance with a second embodiment of the present disclosure.

The media display 102 is substantially square; however, to one skilled in the art the media display 102 may be of different shapes an sizes. In a preferred embodiment, the media display 102 is weather resistant to elements common to horse competition environments such as soil, and moisture.

The frame support 110 is substantially horizontal to accommodate the type of harrow 108. The power supply 106 for the media display 102 is preferably a battery (connections and cables not featured in figure).

Before a horse competition, the advertising apparatus 100 is mounted to a harrow 108 by the frame support 110. The ground needs to be tilled between each competitor. Because there is significant downtime between competitors for tilling the field, there is a perfect opportunity to present targeted ads to the audience. When the harrow 108 is tilling the ground between horse competitors, the advertising apparatus 100 can present advertising material to the viewing audience. After the need for the harrow 108 is complete, the advertising apparatus 100 can be removed and stored for future use.

Arena drags are not commonly transported from one horse competition to another. Arena drags are commonly stored where the stadium equipment is stored. Alternatively, arena drags can be rented for use at a particular venue. There are common models that are frequently used at each venue. Therefore, it is desirable for a removeable advertising apparatus 100 configured for common types of arena drags.

Although the present invention has been described in considerable detail with reference to certain preferred versions thereof, other versions are possible. Therefore, the spirit and scope of the appended claims should not be limited to the description of the preferred versions contained herein. Any element in a claim that does not explicitly state “means for” performing a specified function, or “step for” performing a specific function, is not to be interpreted as a “means” or “step” clause as specified in 35 U.S.C § 112, ¶6. In particular, the use of “step of” in the claims herein is not intended to invoke the provisions of 35 U.S.C § 112, ¶6.

What is claimed is:

1. An advertising apparatus, the advertising apparatus comprising:
a harrow;
at least one media display;
a frame support removably attached to at least one exterior surface of the harrow; and
each media display removably and rotatably attached to the frame support.

2. The advertising apparatus of claim 1, the at least one media display is weather resistant.

3. The advertising apparatus of claim 1, the at least one media display is selected from a group consisting of a static display and an electronic display.

4. The advertising apparatus of claim 1, the frame support removably attached by one or more direct connections.

5. The advertising apparatus of claim 4, the one or more direct connections comprising nuts and bolts, adhesives, or magnets.

6. The advertising apparatus of claim 1, the frame support removably attached by one or more indirect connections.

7. The advertising apparatus of claim 6, the one or more indirect connections comprise cables, clamps, or ties.

8. The advertising apparatus of claim 1, the media display is removably attached by one or more direct connections.

9. The advertising apparatus of claim 8, the direct connections comprise nuts and bolts, adhesives, or magnets.

10. The advertising apparatus of claim 1, the media display is removably attached by one or more indirect connections.

11. The advertising apparatus of claim 10, the indirect connections comprise cables, clamps, or ties.

12. An advertising apparatus, the advertising apparatus comprising:
a harrow;
at least one electronic display;
a frame support removably attached to at least one exterior surface of the harrow; and
each electronic display removably attached to the frame support.
